(19) United States
(12) Patent Application Publication
(10) Pub. No.: US 2007/0026171 A1
(43) Pub. Date: Feb. 1, 2007

(54) High temperature, high strength, colorable materials for use with electronics processing applications

(76) Inventor: Charles W. Extrand, Minneapolis, MN (US)

Correspondence Address: MYKROLIS CORPORATION, 129 CONCORD ROAD, BILLERICA, MA, 01821-4600, US

(21) Appl. No.: 11/371,130

(22) Filed: Mar. 8, 2006

Related U.S. Application Data
(63) Continuation-in-part of application No. 10/654,584, filed on Sep. 3, 2003, now abandoned.
(60) Provisional application No. 60/407,749, filed on Sep. 3, 2002.

(51) Int. Cl. B31B 45/00

(52) U.S. Cl. 428/34.1

(57) ABSTRACT

Certain embodiments include an electrostatic-discharge safe tray for receiving and/or storing electronic components, e.g., read/write heads. Such trays may be made from a mixture of at least one high temperature, high strength polymer, at least one metal oxide, and at least one pigment. The use of the metal oxides as conductive materials advantageously allows for light-colored electrostatic-discharge safe materials to be made, so that such materials may be colored with pigments without compromise of material performance specifications.

### CROSS REFERENCE TO RELATED APPLICATIONS

This application is a continuation in part of U.S. patent application Ser. No. 10/654,584, filed, Sep. 3, 2003, which claims the benefit of U.S. Provisional Patent Application Ser. No. 60/407,749, filed Sep. 3, 2002, the contents of these applications are incorporated by reference in their entirety into the present specification.

### BACKGROUND

Read/Write heads are electronic components that read information on magnetic media and/or write information onto magnetic media. Read/Write heads are used in many electronic devices and are commonly used in computers to read and write information to and from a computer's memory.

Complicated assembly lines are typically used to make the Read/Write heads and to install them into electronic components. The Read/Write heads are stored and transported in special Read/Write head trays that facilitate shipping the heads and processing them at the assembly line. Most Read/Write head trays must prevent any electrostatic discharge (ESD). A tray is made ESD-safe by making the surface that the Read/Write head rests upon into a conductive surface. A conductive surface allows static electricity to dissipate so that a static charge can not build up on the surface.

The Read/Write heads are dark-colored and small; in appearance, they resemble black peppercorns. The Read/Write heads are therefore difficult to see if the tray has a dark color. A dark color makes it difficult to verify that the read/write heads are present in the tray and to remove them from the tray, especially when machine vision is used.

Read/Write head trays are conventionally from a material made by mixing a polymer with stainless steel. The stainless steel is sometimes referred to as a filler because it supplements the polymer's electrical properties by making the polymer into a conductive ESD safe material. The stainless steel is conductive and performs well at high temperatures, but, without pigment, creates a dark color. Stainless steel, however, is difficult to mix with a polymer to achieve a uniform distribution of stainless steel. Without a uniform distribution, the material is more prone to have small insulated spots that compromise the ESD-safe properties of the material. Further, the stainless steel has magnetic properties that could potentially damage the Read/Write heads. Moreover, materials made with stainless steel require high concentrations of pigments to color them, so that other properties of the material are compromised.

### SUMMARY

Versions of the invention include materials comprising a high temperature, high strength polymer and a metal oxide. The materials can be light-colored and can use low amounts or concentrations of pigments to color them. These materials can be formed into articles with fewer burs, threads, or other surface finishing artifacts that are removed before the article can be used.

One version of the invention is a method of using a composite comprising about 40% to about 75% by weight of metal oxide particle dispersed in a high strength and high temperature polymer. The polymer in the composite has a stiffness of at least 2 GPa and a glass transition or melting temperature above 150° C. The composite can be used to make, for example by acts or steps such as but not limited to molding, machining, or a combination of these, an article for receiving an electronic component. The article can be but is not limited to a head tray, chip tray, reticle carrier, wafer carrier, test socket, or the like where the article has a surface resistivity in the range of about 10³ to about 10¹⁴ ohms per square. In some embodiments of the method, the surface resistivity of the tray can be from about 10⁴ to less than about 10⁷ ohms per square. In other versions of the invention the surface resistivity of the tray is about 10¹² to about 10¹⁴ ohms per square. The article can be machined and used without the need to remove burs, threads or other artifact prior to use.

Another embodiment of the invention is a method that comprises using a composite comprising about 40% to about 75% by weight of metal oxide dispersed in a high strength and high temperature polymer, said polymer having a stiffness of at least 2 GPa and a glass transition or melting temperature above 150° C. The composite is used to produce an article for receiving an electronic component where the article has a surface flatter than about 0.015 inches per inch and a surface resistivity in the range of about 10³ to about 10¹⁴ ohms per square. The polymer can be, for example, polyetheretherketone or polyetherketone. In some versions where the the article for receiving an electronic component is machined, it can be made free of threads, burs, or a combination of these.

These problems are solved by making Read/Write head trays that avoid the use of stainless steel. Instead of stainless steel, metal oxide fillers are used; consequently, the materials are colorable. The materials are colorable because they are light-colored and do not require high concentrations of pigments to color them. The materials for making the trays are preferably made with a high temperature, high strength polymer and a metal oxide.

A preferred embodiment of the invention is a Read/Write head tray, at least a portion of the tray comprising an electrostatic discharge-safe surface for receiving a Read/Write head, with the surface being made of a mixture of at least one high temperature, high strength polymer and at least one metal oxide. The lightness of the color of the materials may be measured and assigned an L value in the CIE L*a*b* index (see discussion, below), e.g., more than about 55.

Certain embodiments relate to a colored article for receiving electronic components that is a tray having a plurality of pockets that each have an electrostatic discharge-safe surface that comprises a mixture of at least one high temperature, high strength polymer, at least one metal oxide, and at least one pigment. Certain embodiments relate to a set of trays for electronic component processing, the set having at least two subsets of trays wherein each tray has a plurality of pockets that each comprises an electrostatic discharge-safe surface, with each subset comprising a subset color distinct from the other subset colors. Certain embodiments relate to an article for receiving electronic components, the article having a structure for contacting and supporting an electronic component, and with the structure comprising at least one electrostatic discharge-safe surface that comprises a mixture of at least one high temperature, high strength polymer and at least one metal oxide, wherein the surface has an L value of more than about 55 or 65.

Certain embodiments relate to an article for receiving electronic components, the article comprising a tray having a plurality of pockets, each pocket comprising at least one electrostatic discharge-safe surface that comprises a mixture of at least one high temperature, high strength polymer at least one metal oxide, and at least one pigment, wherein the surface has an L value of more than about 55 or 65. Certain embodiments relate to a method of producing an article for electronic processing, the method comprising: molding a tray having a pocket that comprises an electrostatic discharge-safe surface that comprises a high temperature, high strength polymer and a conductive filler, wherein the surface comprises, an L value of at least about 55 or 65, and a resistivity in the range of 10³ to 10¹⁴ ohms per square, wherein the surface is flatter than an average of about 0.1 or 0.015 inches per inch. Certain embodiments relate to a method of producing an article for electronic processing, the method comprising molding a tray having a pocket that comprises an electrostatic discharge-safe surface that comprises a high temperature, high strength polymer and a conductive filler, wherein the surface comprises, an L value of at least about 55 or 65, and a resistivity in the range of 10³ to 10¹⁴ ohms per square, wherein the surface is flatter than an average of about 0.1 or 0.015 inches per inch.

### BRIEF DESCRIPTION OF THE FIGURES

FIG. 1 depicts the coordinate system for 1976 CIE L*a*b* Space and the L value for certain embodiments;

FIG. 2 depicts a multipocketed tray for receiving electrical components;

FIG. 3 depicts a cross-section of FIG. 2 in a view as indicated by line 3-3 in FIG. 2; and

FIG. 4 depicts a plurality of the trays of FIG. 2 in a stacked configuration.

### DESCRIPTION

Before the present compositions and methods are described, it is to be understood that this invention is not limited to the particular molecules, compositions, methodologies or protocols described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a”, “an”, and “the” include plural reference unless the context clearly dictates otherwise. Thus, for example, reference to a “metal oxide particle” is a reference to one or more metal oxide particles and equivalents thereof known to those skilled in the art, and so forth. Unless defined otherwise, all technical and scientific terms used herein have the same meanings as commonly understood by one of ordinary skill in the art. Although any methods and materials similar or equivalent to those described herein can be used in the practice or testing of embodiments of the present invention, the preferred methods, devices, and materials are now described. All publications mentioned herein are incorporated by reference. Nothing herein is to be construed as an admission that the invention is not entitled to antedate such disclosure by virtue of prior invention.

A preferred embodiment of the invention is an ESD-safe Read/Write head tray that is light in color, is made of a high temperature, high strength polymer, and contains a metal oxide filler. The metal oxide filler preferably includes ceramics.

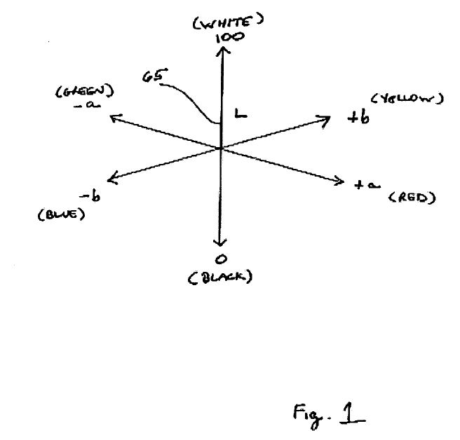

The lightness of the color of a material is objectively quantifiable using the Commission Internationale d'Eclairage L*a*b* color system (CIELab, see K. McLaren The Development of the CIE 1976 (L*a*b*) Uniform Colour-Space and Colour-Difference Formula, J. Society of Dyers and Colourists, 92:338-341 (1976) and G. A. Agoston, Color Theory and Its Application in Art and Design, Hedelberg, 1979). As shown in FIG. 1, the 1976 CIE L*a*b* system assigns every color a position on a three-coordinate axis. L is the measure of lightness, and has a value that ranges from 0 (black) to 100 (white). “L” is used herein for the 1976 CIE L*a*b* system: elsewhere, L* may be used to refer to the same value described herein as “L”. The a* axis indicates the amount of red or green and the b* axis indicates the amount of yellow or blue. Thus a value of 0 for both “a*” and “b*” indicates a balanced gray. Since the CIELab system is device-independent, it is a popular choice for computer imaging applications. The CIELab values are measurable using standardized tests that are familiar to those skilled in these arts, for example, by using a reflectance meter. For example, reflectance meters are manufactured by Photovolt Instruments, Inc., Minneapolis, Minn., (Photovolt Model 577 and by Minolta Corporation, Ramsey, N.J., (model Minolta CM 2002). Thus L is an objective, quantifiable, and reproducible measure of the lightness of any color.

Referring to FIG. 1, certain embodiments of materials are set forth herein that provide for an L value that ranges from essentially 0 to about 100. For example, a very dark, near black, color may be achieved by mixing polymers with carbon black to achieve an L value of close to 0. And white pigments, e.g., titanium oxides, can be added to achieve a near-white color close to 100. An example of an electrostatic discharge-safe material suitable for use as a support for electronic component processing having a light color is a polyetheretherketone mixed with about 54% by weight antimony-doped tin oxide conductive material, which has an L value of 64.9, see “65” in FIG. 1, as measured using a reflectance spectrophotometer with output programmed for the CIELab system. The other samples described herein have been visually determined to fall within the ranges as set forth, below.

In contrast to conventional processing methods in the relevant field of art, certain embodiments set forth herein provide for materials having a high L value while maintaining suitable mechanical and electrostatic discharge-safe conductive properties. Moreover, certain embodiments retain moldability characteristics such as flatness. An aspect of certain of these embodiments is the use of metal oxides or ceramics to achieve the electrostatic discharge-safe and coloration properties. Another aspect of certain of these embodiments is the use of high temperature, high strength polymers. Another aspect of certain of these embodiments is the use of isotropic flow particles. All ranges in the continuum from about 0 to about 100 are contemplated. Other embodiments achieve colorations having an L value of at least about 33, about 45, about 55, about 66, or about 80. Some embodiments have colorations that fall within an L value ranging from about 45 to about 100, from about 55 to about 99, and from about 66 to about 90. For example, a material with an L value of more than about 55 would mean that the material in question was closer to white on the CIELab scale than a material with an L value of about 55. As described herein, the conductive, polymeric, and conductive material concentrations are adjusted until a desired combination of mechanical, color, or conductive properties are achieved for the contemplated application. Such adjustment could readily be performed by a person of ordinary skill in these arts after reading this disclosure.

A high temperature, high strength polymer is preferably one having high resistance to heat and chemicals. The polymer is preferably resistant to the chemical solvent N-methyl pyrilidone, acetone, hexanone, and other aggressive polar solvents. A high temperature, high strength polymer has a glass transition temperature and/or melting point higher than about 150° C. Further, the high strength, high temperature polymer preferably has a stiffness of at least 2 GPa.

Examples of high temperature, high strength polymers are polyphenylene oxide, ionomer resin, nylon 6 resin, nylon 6,6 resin, aromatic polyamide resin, polycarbonate, polyacetal, polyphenylene sulfide (PPS), trimethylpentene resin, polyetheretherketone (PEEK), polyetherketone (PEK), polysulfone (PSF), tetrafluoroethylene/perfluoroalkoxyethylene copolymer (PFA), polyethersulfone (PES), high-temperature amorphous resin (HTA), polyallylsulfone (PASF), polyetherimide (PEI), liquid crystal polymer (LCP), polyvinylidene fluoride (PVDF), ethylene/tetrafluoroethylene copolymer (ETFE), tetrafluoroethylene/hexafluoropropylene copolymer (FEP), tetrafluoroethylene/hexafluoropropylene/perfluoroalkoxyethylene terpolymer (EPE), and the like. Mixtures, blends, and copolymers that include the polymers described herein may also be used. Especially preferable are PEK, PEEK, PES, PEI, PSF, PASF, PFA, FEP, HTA, LCP and the like. Examples of high temperature, high strength polymers are also given in, for example, U.S. Pat. Nos. 5,240,753; 4,757,126; 4,816,556; 5,767,198, and patent applications EP 1 178 082 and PCT/US99/24295 (WO 00/34381) which are hereby incorporated herein by reference.

A metal oxide filler is a conductive or a semiconductive material that includes metal oxide and can be added to a high temperature, high strength polymer to create an ESD safe material having a light color and sufficient mechanical properties for use as a Read/Write head tray. In some versions a metal oxide filler is a conductive or a semiconductive material that includes metal oxide and can be added to a high temperature, high strength polymer to create a material having a light color and sufficient mechanical properties for use as an article for processing electronic components. The metal oxides are preferably mixed with ceramics or coated upon ceramics e.g., metal oxide doped ceramics. Such fillers typically have a light color that allows them to be used to make a light colored material. Since they have a light color, other coloring agents may be added to impart a particular color to the material. Further, ceramics are durable, and metal oxide/ceramic combination materials typically have electroconductive properties that are independent of humidity. A ceramic is a material consisting of compounds of a metal combined with a non-metallic element. Ceramics include metal oxides.

Examples of suitable metal oxides are exemplified by aluminum borate, zinc oxide, basic magnesium sulfate, magnesium oxide, potassium titanate, magnesium borate, titanium diboride, tin oxide, and calcium sulfate. This list of oxides is exemplary and not intended to limit the scope of the invention. Further examples of fillers are provided in, for example, U.S. Pat. Nos. 6,413,489; 6,329,058; 5,525,556; 5,599,511; 5,447,708; 6,413,489; 5,338,334; and 5,240,753, which are hereby incorporated herein by reference. In general, the metal oxides may be doped or coated with another metal as needed to impart or enhance conductivity. In some versions of the invention the metal oxide particles are not coated or doped. In some versions of the invention the metal oxide particles may be characterized as being wide band gap semiconductors; in some versions the bandgap is greater than about 2.5 eV. For example, ZnO has a bandgap of about 3.3 eV, MgO has a bandgap of about 7.9 eV, titanium dioxide (anatase) has a bandgap of about 3.2 eV, and tin oxide (SnO₂ ) has a bandgap of about 3.6 eV.

A preferred filler is tin oxide, particularly antimony-doped tin oxide. In some versions of the invention the metal oxide filler can be titanium dioxide, and in still other versions antimony-doped tin oxide coated on titanium dioxide, for example, the family of products provided under the trade name Zelec® by Milliken Chemical Co. These products are small, roughly spherical-shaped, and light blue-gray to light green-gray in color. These colors allow for the creation of materials with a wide range of light colors, including white. Further, the antimony-doped tin oxide materials can be used to make transparent films and have the advantages of most ceramics, such as, non corrosiveness, resistance to acids, bases, oxidizers, high temperatures, and many solvents.

Another preferred class of fillers is whiskers, especially titanate whiskers, and more particularly potassium titanate and aluminum borate whiskers, which are described in, for example, U.S. Pat. Nos. 5,942,205 and 5,240,753, which are hereby incorporated herein by reference. The term whisker refers to a single crystal filament having a cross-sectional area of up to about 8×10⁻⁵ of a square inch and a length of about at least 10 times the average diameter. Whiskers are typically free of flaws and are therefore much stronger than polycrystals that have a similar composition. Thus certain whisker fillers can improve the strength of a composite material as well as impart other properties such as improved rigidity, abrasion resistance, and electrostatic dissipation. A preferred class of whiskers are provided under the trade name DENTALL by Otsuma Chemical Co., Japan; these are ceramic whiskers coated with a thin layer of tin oxide.

The sizes and shapes of the fillers are not limited and may be e.g., whiskers, spheres, particles, fibers, or other shapes. The sizes of the fillers are not limited, but small particles such as whiskers or comparably sized spheres, or very small sizes are preferable. Technologies for making very small particles, e.g., using nanotechnology, may be employed.

Suitable metal oxide fillers may be disposed in a variety of configurations. For example, an inert core particle may be coated with a metal oxide. The metal oxide coating is thus extended by the inert particle to result in a less expensive product. Alternatively, a hollow core may be used instead of an inert particle. Or, the size of the particles may be made smaller by omitting the core. Or, a ceramic may be doped with a metal oxide. Doped materials can be conductive while retaining the mechanical and coloring properties of the ceramic.

The metal oxide conductors should be disbursed in the material so that three-dimensional interconnecting networks of the conductors are formed. In some versions the metal oxide particles can be dispersed in the high strength high temperature polymer material so that a three-dimensional interconnecting network of the metal oxide particles are formed in the composite. In some versions the metal oxide particles can be dispersed in the material so that the composite of polymer and the metal oxide particles has a stiffness greater than the polymer. The networks serve as a circuit to drain static charges. The concentration of the metal oxide conductors is related to the ESD properties of the material. The composite or articles produced from it can have a surface resistivity of about 10³ to about 10¹⁴ ohms per square, in some versions the composite or articles produced from it can have a surface resistivity of from about 10³ to about 10⁷ ohms per square, in some versions the composite or articles produced from it can have a surface resistivity of from about 1 to about 1014 ohms per square, and in some versions the composite or articles produced from it can have a surface resistivity of from about 10¹² to about 10¹⁴ ohms per square. Very low concentrations of metal oxide conductors, or metal oxide semiconductors, or a combination of these, create a high surface resistivity. The resistivity drops slowly as the concentration of metal oxide conductors is increased until a “percolation threshold” is reached when the metal oxide conductors begin touching each other and further increases in the metal oxide conductor concentration cause rapid drops in resistivity. Eventually, a ceramic concentration is reached wherein further increases in the metal oxide conductor concentration fails to create substantial drops in resistivity because the metal oxide conductors have already formed an optimal number of networks. Some versions of the composite material dissipates a static charge in greater than about 100 seconds, and in some versions greater than about 120 seconds. In some versions the composite material dissipates a static charge in less than about 100 seconds and in some versions about 0.03 seconds, or less. Typically, the addition of materials having less conductivity than the metal oxide conductors will result in increased surface resistivity. Thus, the addition of pigments can affect surface resistivity but compositions that have a desired resistivity can be made by adjusting the amounts of pigment and conductive filler.

There are numerous advantages to having a light-colored material for a Read/Write head tray. One advantage is that the Read/Write heads may be visualized. Another advantage is that the trays are colorable. Thus the color may be optimized to make the heads more easily visible. Or different types of Read/Write head trays may be made with different colors so that different models and applications of trays maybe easily recognized by a user. Or various types or sizes of heads may be stored in trays of different colors so that shipping and use of the heads is efficient.

Certain embodiments further incorporate pigments to achieve not only a desired L value, but also a particular color, e.g., red, green, blue, yellow, or combinations thereof. The pigments are added in a concentration suitable to achieve the desired color. The desired coloration may be accomplished by adding pigments known to those skilled in these arts, and mixing them with conductive materials and polymers as described herein to achieve a desired color, conductivity, and mechanical characteristics. Examples of pigments include titanium dioxide, iron oxide, chromium oxide greens, iron blue, chrome green, aluminum sulfosilicate, cobalt aluminate, barium manganate, lead chromates, cadmium sulfides and selenides. Carbon black may be used if a black color is desired or if the carbon black is used in concentrations that do not create an overly dark or black color. Colors that may be achieved with the use of pigments spans the spectrum of visible light, including white.

The filler(s) are preferably present in amounts sufficient to make the Read/Write head tray have a surface resistivity in the range of about 10³ to about 10¹⁴ ohms per square, a range that embues the surface with ESD-safe properties; more preferably the surface resistivity is in the range between about 10⁴ to less than about 10⁷ ohms per square. Further, the filler is preferably evenly distributed through the material so as to avoid small insulated spots that compromise its ESD-safe properties. Further, the filler is preferably present in the concentration that avoids creating a black color in the material, and more preferably avoids creating a dark color in the material. The concentration of carbon black that is required to make an ESD safe material causes the material to be dark, and essentially black. Microchip trays are conventionally made with carbon black.

A material made of a polymer and a carbon filler is commonly used to make microchip trays for holding microchips. Prior art microchip trays, however, are not suitable for use as Read/Write head trays because the microchip trays are very dark colored due to the presence of the carbon filler. In a microchip tray, the Read/Write heads would be difficult to see because the Read/Write heads are small and dark and the microchip tray is dark. As a result, it would be difficult to use such prior art trays in conjunction with Read/Write heads. Further, an acceptable chip tray surface resistivity is usually in the range of at least about 10⁷ to 10⁸ per square. In contrast, an acceptable read/write head tray surface resistivity is usually in the range of about 10⁴ to less than about 10⁷ ohms per square. A semiconducting, conductive, or combination of these metal oxide or ceramic materials can be added to a high temperature, high strength polymer to create a composite material or article with one or more surfaces that are flatter than an average of about 0.015 inch per inch and having a surface resistivity of from about 10³ to about 10¹⁴ ohms per square. For example, such a material with a resistivity of, e.g., 10⁴ ohms per square has more filler than a material with a resistivity of, e.g., 10⁸ ohms per square. Because of the uncertainties associated with increasing the amount of filler to high levels, approaches for making the ESD safe materials for computer chip trays can not be assumed to be transferable to read/right head trays. Moreover, materials used for use with computer chip processing, for example wafer carriers, have very low levels of extractable metal ions, but this is not a major concern for Read/Write head tray materials. Therefore technologies and approaches for making microchip trays are not applicable to making Read/Write head trays.

For these reasons, scientists making Read/Write head trays have developed technologies that are different from technologies for making computer chip trays. Instead of using a carbon filler, Read/Write head trays are conventionally made with a metallic filler such as stainless steel. The stainless steel is conductive, performs well at high temperatures, and does not create a dark color in the material. Since the material is not dark, the read/write heads may be readily visualized.

The inventors have unexpectedly found the surprising result that high temperature, high-strength polymers may be mixed with more than about 40% ceramics by weight to achieve an ESD safe material without losing desirable processing properties such as moldability and flowability and without losing desirable mechanical properties such as compressive and tensile strength and appropriate rigidity. This result is surprising because, although polymers may be mixed with moderate amounts of non polymeric materials without losing the desirable properties of the polymer in the final product, the addition of a large amount of non polymeric materials, i.e. more than about 40% by weight, would be expected to result in a final product with properties that did not resemble those of the polymer. Ceramics treated with, or doped with, metal oxides are preferable for creating ESD safe materials. Large amounts of such ceramics, however, are typically required to achieve the desired conductivity in the materials. The preferred concentration range of ceramics is between about 40% and about 75%, a more preferred concentration range is between about 45% percent and about 70%, and a yet more preferable range is between about 50% and about 60%.

Moreover, it is surprising that the addition of more than about 40% by weight metal oxides and/or ceramics to a high strength, high temperature polymer can result in materials having surfaces that are flat, and even more surprisingly, flatter than surfaces achieved with stainless steel. In fact, however, the use of metal oxides with a high strength, high temperature polymer results in a Read/Write head tray that is more flat than trays made with stainless steel. The term smooth may sometimes used to refer to a lack of warp, as was the case in the priority document of this application, but, for the sake of clarity, the term flat is adopted herein to denote a lack of warp. Warp is curvature that is sometimes undesirably introduced into a surface in a molding or other processing step. The term flat is thus not to be confounded with measures of roughness. Flatness is a desirable feature of Read/Write head trays. One possible reason for the unexpected flatness is that the metal oxides used in the flat surfaces have isotropic flow shapes. An isotropic flow shape is a shape that resists becoming oriented in any particular direction as a result of forces created by a flowing fluid; in other words the flow characteristics of the particle are approximately the same in all directions. Thus a spherical particle has an isotropic flow shape because the particle does not become oriented in any particular direction when the particle is mixed in a flowing fluid. In contrast, a rod-shaped particle does not have an isotropic flow shape because it tends to align its longest axis in the direction parallel to the direction of flow.

The ceramic or metal oxide based compositions machine or polished more easily than unfilled high temperature high strength polymers like PEEK, generating fewer burs and threads. This can be determined visually by comparing machined surfaces of these materials with test patterns of varying size and shape and comparing the number of threads and or burs produced in a given machined or polished area. Additionally, particle counting by light scattering or other methods may be used on as machined samples of the high strength high temperature polymer to compare surface counts caused by threads, particles, or burs. The inventors have discovered that high temperature high strength polymers like PEEK or PEK comprising from about 40% to about 75% by weight metal oxide particles can be machined with fewer threads or burs compared to a sample of PEEK without filler. Without wishing to be bound by theory, the improvement in machinability with generation of less threads, burs, or particles, or a combination of these for metal oxide filled versus unfilled polymer, may be due to the increased stiffness of the filled polymer compared to the unfilled polymer. Consequently, during machining of the filled polymer, the tool cutter will be more likely to break away small chips of the ceramic or metal oxide filled polymer as it progresses through the filled material, as opposed to elongating and tearing the tougher unfilled high temperature high strength polymer.

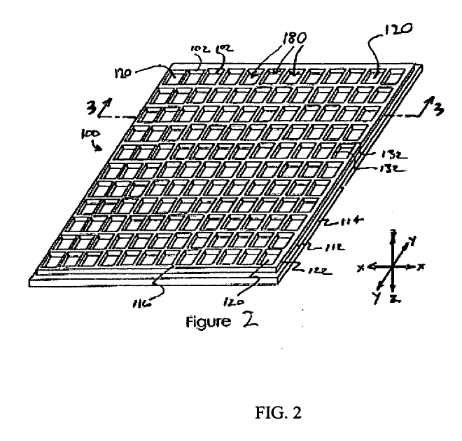

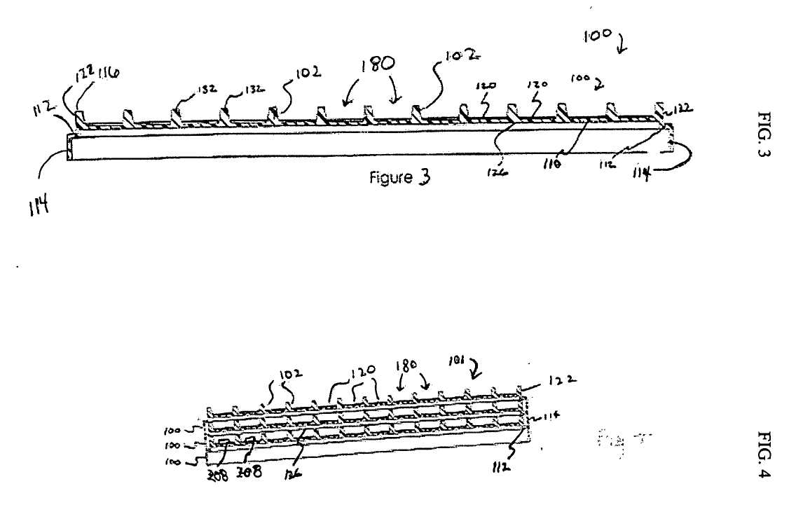

Many embodiments herein have been described in terms of Read/Write head trays because that is a preferred embodiment. However, these descriptions should also be understood as applying more generally to all types of trays that used in electronic processing. Trays are used, for example, for microchips, computer components, and audio component processes, see also U.S. Pat. No. 6,079,565 and U.S. patent Ser. No. 10/241,815, filed Sep. 11, 2002, which are hereby incorporated herein by reference. Electronic processing includes those manufacturing processes that involve assembling components for the electronics industry. Such processes may include but are not limited to coating, polishing, assembly, testing, housing, or shipping of electronic or microelectronic devices with articles comprising the metal oxide polymer composites of the invention. Trays are useful for such processes because the components be moved and/or stored in a fashion that is convenient and protects the components from contaminations and static discharges. A tray includes an electrostatic discharge-safe surface that receives and contacts an electronic component to thereby support it. Trays have a plurality of pockets, for example, as in FIGS. 2 and 3. The component is contained by the tray pocket, which may be, for example, an indentation, a space surrounded by walls, posts, or protrusions, a groove, or other structure that limits the component's mobility while on the tray so that the tray can successfully be moved without dislodging the component from the tray. Trays are preferably stackable (FIG. 4) and the stacks are preferably also stackable, e.g., on pallets, so as to facilitate processing.

A surface may comprise a material by molding the surface from the material. A surface of an article in versions of the present invention may comprise a composite of the metal oxide and high temperature and high strength polymer produced by molding, machining, or a combination of these acts performed on a sample of the composite. In some embodiments the article is a tray for an electronic component, such as but not limited to a head tray, chip tray, test socket, wafer carrier, or reticle carrier, where the tray has a surface resistivity in the range of about 10³ to about 10¹⁴ ohms per square, in some versions from about 10¹² to about 10¹⁴ ohms per square, and in still other versions above about 10¹² ohms per square. Thus the materials in the surface are known if the material from which the surface is molded are known. Thus a surface may be assumed to resemble a material's bulk composition, even though it is appreciated that the very uppermost portions of a surface can have a composition that is distinct form the bulk of the material. Further, a surface may be determined to have an average flatness that is measurable in inches per inch. Conventional flatness measurements or L value calorimetric measurements may be used that provide an average for a significant portion of the surface. Such measurements can thus be distinguished from measurements that provide an average for a very small portion of the surface, e.g., atomic force microscopy.

Referring to FIGS. 2-4, which depict a tray 100 having a plurality of pockets 180. The pockets 180 have bottom surfaces 120 that form sides 102 that contain objects on the bottom surfaces 120. The top surface 132 of tray 100 is continuous and defines separations between pockets 180. Outer edge 116 of top surface 132 is continuous with and perpendicular to upper tray side 122. Tray side 122 is perpendicular to lip 112. Lip 112 is perpendicular to lower tray side 114. Referring to FIG. 4, trays 100 may be placed in a stacked configuration 101 without bottom tray surface 126 impinging on an electrical component, e.g., depicted by 208. Lip 112 acts as a stop for bottom tray surface 126.

### EXAMPLE 1

Prototype Read/Write head trays were prepared by molding them from a mixture of metal oxide ceramics with PEEK, as indicated in Table 1. The molding process was essentially the same as the process used for PEEK loaded with stainless steel, although the molding temperature was adjusted slightly downwards. The results of these experiments showed that Zelec® ECP 1410T was a preferable metal oxide ceramic for use in making light colored Read/Write head trays. Moreover, the high temperature, high-strength polymer could be loaded with more than 40 percent of the filler without compromising the mechanical properties needed for the Read/Write head trays. Furthermore, the surfaces for holding the Read/Write heads were surprisingly found to be flat, with a flatness that exceeded the flatness obtained with stainless steel fillers.

TABLE 1
Mixtures of metal oxide particles with high temperature,
high strength polymer

| | | | Surface resistivity |
|---|---|---|---|
| Metal Oxide Filler | Loading (wt %) | Color | (ohms/sq) |
| Zelec ® ECP 1410T | 40 | Light Gray | 10¹³ |
| Zelec ® ECP 1410T | 60 | Light Gray | 10⁵ |
| Zelec ® ECP 1410M | 40 | Dark Gray | 10⁵ |
| Zelec ® ECP 1410M | 60 | Did not work | — |
| Zelec ® ECP 1410XC | 40 | Did not work | — |
| Zelec ® ECP 1410XC | 60 | Did not work | — |

### EXAMPLE 2

Prototype Read/Write head trays were prepared by molding them from a mixture PEEK and a metal oxide ceramic, as indicated in Table 2. The molding process was essentially the same as the process used for PEEK loaded with stainless steel, although the molding temperature was adjusted slightly downwards. The results of these experiments showed that metal oxide ceramics could be used to make light colored Read/Write head trays that are ESD safe. Moreover, the high temperature, high-strength polymer could be loaded with more than 40 percent of the filler without compromising the mechanical properties needed for the Read/Write head trays.

TABLE 2
ESD properties of mixtures of metal oxide particles with high temperature,
high-strength polymer.

| | Surface resistivity | Static Dissipation |
|---|---|---|
| Loading (wt %) | (ohms/sq) | (seconds) |
| 40 | 10¹³ | 100 |
| 47 | 10¹³ | 120 |
| 52 | 10⁷ | 0.03 |
| 54 | 10⁵ | 0.03 |
| 60 | 10⁵ | 0.03 |
| 60 | 10⁵ | 0.03 |

### EXAMPLE 3

The properties of various compositions of PEEK mixed with metal oxide ceramics were compared, as indicated in Table 3, with a carbon fiber composition (18% wt.) and neat mixture of PEEK used as controls. Zelec® ECP 1410T (52%) was used as the metal oxide ceramic. The molding process was essentially the same as the process used for PEEK loaded with stainless steel, although the molding temperature was adjusted slightly downwards for most compositions. Shrinkage in the prototype head trays ranged from 0.008 to 0.013 in/in, an acceptable amount. Further, the prototypes were remarkably flat. The first prototype head tray model had a surface for receiving a Read/Write head having an average flatness of 0.004±0.001 in/in with a maximum of 0.007 in/in. a second prototype head tray model had a surface for receiving a Read/Write head that had an average flatness of 0.013±0.010 in/in with a maximum of 0.017 in/in.

The results of these experiments showed that metal oxides could be used to make light colored ESD safe Read/Write head trays with more than 40 percent by weight of metal oxide filler without compromising the mechanical properties needed for the head trays. Further, these experiments showed that unexpectedly flat surfaces could be obtained using a high temperature, high strength polymer in combination with a metal oxide, such as a metal oxide ceramic.

TABLE 3
Properties of various compounds of metal oxides and PEEK.

| | | | Metal Oxide |
|---|---|---|---|
| | Neat | Carbon Fiber (18%) | Ceramic (52%) |
| Specific Gravity | 1.3 | 1.4 | 2.1 |
| Melt Temperature | 349 | 344 | 344 |
| (° C.) | | | |
| Modulus (GPa) | 3.9 | 11 | 6.5 |
| Break Stress (MPa) | 80 | 110 | 90 |
| Break Strain (%) | 50 | 1.8 | 1.8 |

### EXAMPLE 4

The resin purity properties of various compositions of PEEK mixed with metal oxide ceramics were compared, as indicated in Table 4, with a carbon fiber composition (18% wt.) and neat mixture of PEEK used as controls. Zelec® ECP 1410T (52% wt) was used as the metal oxide ceramic. The outgassing was measured by maintaining a sample for 30 minutes and a 10 Tenax tube at 100° C. and analyzing the released gasses using an automated thermal desorption unit-gas chromatograph/mass spectrograph. Metals were analyzed by placing plaques of the material in dilute nitric acid at 85° C. for one-hour and analyzing the extracted metals by ICP/MS inductively coupled plasma/mass spectrometer. Anions were analyzed by exposing the material to dilute water at 85° C. for one-hour, followed by analyzing the water by ion chromatography. Table 5 shows the metals recovered. Table 6 shows the anions recovered.

The results of these experiments showed that the metal oxide ceramics had significantly more extractable metals than comparable materials formed using carbon fiber. The amount of extracted metals, however, was adequate for use in a Read/Write head tray.

TABLE 4
Resin purity for various high temperature, high-strength compounds
containing metal oxides.

| | | | Metal Oxide |
|---|---|---|---|
| | Neat PEEK | Carbon Fiber (18%) | Ceramic (52%) |
| Outgassing | 0.6 | 0.62 | 0.5 |
| (μg/gram) | | | |
| Metals (ng/g) | 6658 | 1057 | 2278 |
| Anions (ng/g) | 464 | 1104 | 419 |

TABLE 5
Metal levels of the compositions of Table 4.
Metals Present

| | |
|---|---|
| Neat | Neat Al, Ca, Co, Fe, K, Na, Ni, Pb, Sn, Ti |
| Carbon Fiber (18%) | B, Ca, Co, Fe, K, Mg, Na, Ni, Zn |
| Metal Oxide | Al, B, Ba, Ca, Co, Cr, Cu, Fe, K, Mg, Mn, Na, |
| Ceramic (52%) | Ni, Pb, Sb, Sn, Ti, Zn |

TABLE 6
Anions of the various PEEK compounds of Table 4.

| Anion (ng/g) | Neat | Carbon Fiber (18%) | Metal Oxide (52%) |
|---|---|---|---|
| Fluoride | 410 | 34 | 56 |
| Chloride | BDL | 400 | 280 |
| Nitrate | BDL | 130 | 14 |
| Sulfate | 10 | For 70 | 60 |
| Phosphate | 44 | BDL | 900 |

BDL indicates below detection limits

The embodiments described herein are provided as examples of the invention and are not intended to limit the scope and spirit of the invention. All patents and publications set forth in this application are hereby incorporated herein by reference.

An embodiment of the invention is a read/write head tray, at least a portion of the tray comprising an electrostatic discharge-safe surface for receiving a read/write head, with the surface being made of a mixture of at least one high temperature, high strength polymer and at least one metal oxide. Another embodiment of the invention is a tray made with a high temperature, high strength polymer chosen from the group consisting of polyphenylene sulfide, polyetherimide, polyarylketones, polyetherketone, polyetheretherketone, polyetherketoneketone, and polyethersulfone. Another embodiment of the invention is a tray wherein the at least one metal oxide is chosen from the group consisting of aluminum borate, zinc oxide, basic magnesium sulfate, magnesium oxide, graphite, potassium titanate, magnesium borate, titanium diboride, tin oxide, calcium sulfate, and antimony doped tin oxide. Another embodiment of the invention is a tray wherein the metal oxide is disposed in particles, and the particles are present in the mixture at a concentration of at least 40 percent by weight, or at a concentration of between 50 and 70 percent. The particles may also further comprise a ceramic. Further the metal oxide may be disposed in a whisker. Moreover, the whiskers may be chosen from the group consisting of whiskers made of potassium titanate and aluminum borate. Another embodiment of the invention is a filler comprising metal oxide disposed in a particle, wherein the particle has an isotropic flow shape.

1-63. (canceled)

64. A method of using a composite comprising about 40% to about 75% by weight of metal oxide particles dispersed in a high strength and high temperature polymer, said polymer having a stiffness of at least 2 GPa and a glass transition or melting temperature above 150° C. to produce an article for receiving an electronic component where the article has a surface resistivity in the range of about 10³ to about 10¹⁴ ohms per square.

65. The method of claim 64 where the surface resistivity of the article is about 10⁴ to less than about 10⁷ ohms per square.

65. The method of claim 64 where the surface resistivity of the article is 10¹² to about 10¹⁴ ohms per square.

66. The method of claim 64 where the article has an L value of at least about 55.

67. The method of claim 64 wherein said polymer includes polyetheretherketone or polyetherketone.

68. The method of claim 64 where the article has a plurality of pockets.

69. The method of claim 64 where the metal oxide particles have an isotropic shape.

70. The method of claim 64 where the metal oxide is titanium dioxide.

71. A method of using that comprises: a composite comprising about 40% to about 75% by weight of metal oxide particles dispersed in a high strength and high temperature polymer, said polymer having a stiffness of at least 2 GPa and a glass transition or melting temperature above 150° C. and producing an article for receiving an electronic component from said composite where the article has a surface flatter than 0.015 inches per inch and a surface resistivity in the range of about 10³ to about 10¹⁴ ohms per square.

72. The method of claim 71 where the article for receiving an electronic component has a surface produced by machining.

73. The method of claim 71 where the article for receiving an electronic component has a surface resistivity of from about 10¹² to about 10¹⁴ ohms per square.

74. The method of claim 71 where the composite has an L value of at least about 55.

75. The method of claim 71 where the polymer includes polyetheretherketone or polyetherketone.

76. The method of claim 71 where the article for receiving an electronic component has a plurality of pockets.

77. The method of claim 71 where the article for receiving an electronic component is machined free of threads, burs, or a combination of these.

78. The method of claim 71 where the metal oxide comprises titanium dioxide.

79. The method of claim 71 where the composite further comprises a colorant.
